(19) United States
(12) Patent Application Publication
(10) Pub. No.: US 2017/0284395 A1
(43) Pub. Date: Oct. 5, 2017

(54) ELECTRIC COMPRESSOR

(71) Applicant: KABUSHIKI KAISHA TOYOTA JIDOSHOKKI, Kariya-shi (JP)

(72) Inventors: Hiroshi FUKASAKU, Aichi-ken (JP); Ken SUITOU, Aichi-ken (JP)

(73) Assignee: KABUSHIKI KAISHA TOYOTA JIDOSHOKKI, Kariya-shi (JP)

(21) Appl. No.: 15/472,707

(22) Filed: Mar. 29, 2017

(30) Foreign Application Priority Data
Mar. 31, 2016 (JP) 2016-072532

(51) Int. Cl. F04C 29/00; H02K 1/14; F04C 21/00; H02K 11/30; F04C 18/02; F04C 18/344

(52) U.S. Cl. CPC F04C 29/0085; F04C 18/0215; F04C 18/344; F04C 21/00; H02K 11/30; H02K 1/146; F04C 2210/26; F04C 2240/40; F04C 2240/30; F04C 2240/60

(57) ABSTRACT

An electric compressor includes a cylindrical housing, a rotary shaft accommodated and rotatably supported in the housing, a compression portion compressing refrigerant gas by rotation of the rotary shaft, a stator accommodated in the housing and fixed to the housing, a rotor accommodated in the housing and fixed on the rotary shaft, and a plurality of guide members disposed between the inner peripheral surface of the housing and an outer peripheral surface of a stator core of the stator. A plurality of recesses is recessed in a radial direction of the rotary shaft on the outer peripheral surface of the stator core of the stator and spaced apart from each other in a peripheral direction of the rotary shaft. The guide members are fitted in the respective recesses with a part of the guide members projecting radially outward beyond the outer peripheral surface of the stator core.

### BACKGROUND OF THE INVENTION

The present invention relates to an electric compressor.

In general electric compressors, a stator of an electric motor is shrink-fitted to an electric motor. However, apparatuses for shrink fitting are large in size and expensive, and the cycle time for the shrink fitting is prolonged by the necessity of time for heating and cooling. Furthermore, high dimensional accuracy is required for the inner diameter of a housing and the outer diameter of a stator. Japanese Patent Application Publication 2014-20231 discloses an electric compressor in which a guide member made of a sheet material is provided on the outer periphery of the stator and the stator is press-fitted on the inner peripheral surface of the housing by way of the guide member.

In the electric compressor of the above Publication, the guide member is movable in the peripheral direction of the rotary shaft relative to the stator core and therefore, displacement or slippage of the guide member in the peripheral direction may occur in press-fitting operation, with the result that the stator core may be damaged due to the contact of the stator core and the housing.

The present invention which has been made in light of the above problems is directed to providing an electric compressor in which the displacement or slippage of the guide member in the peripheral direction of the rotary shaft relative to the stator core is restricted.

### SUMMARY OF THE INVENTION

In accordance with one aspect of the present invention, there is provided an electric compressor including a cylindrical housing, a rotary shaft accommodated and rotatably supported in the housing, a compression portion compressing refrigerant gas by rotation of the rotary shaft, a stator accommodated in the housing and fixed to an inner peripheral surface of the housing; a rotor accommodated in the housing and fixed on the rotary shaft, and a plurality of guide members disposed between the inner peripheral surface of the housing and an outer peripheral surface of a stator core of the stator. A plurality of recesses is recessed in a radial direction of the rotary shaft on the outer peripheral surface of the stator core of the stator and spaced apart from each other in a peripheral direction of the rotary shaft. The guide members are fitted in the respective recesses with a part of the guide members projecting radially outward beyond the outer peripheral surface of the stator core.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which;

FIG. 1 is a longitudinal sectional view of an electric compressor according to an embodiment of the present invention;

FIG. 2 is a transverse sectional view of the electric compressor taken along the line 2-2 of FIG. 1;

FIG. 3A is a fragmentary front view showing a stator core of a stator and a guide member of the electric compressor of FIG. 1;

FIG. 3B is a fragmentary sectional side view showing a motor housing, as well as the stator core and the guide member, of the electric compressor taken along the line A-A of FIG. 3A;

FIG. 3C is a fragmentary sectional view of the electric compressor, taken along the line B-B of FIG. 3A;

FIG. 4 is a perspective view of the guide member of FIGS. 3A to 3C;

FIG. 5 is a longitudinal sectional view of the electric compressor of FIG. 1, showing a manner in which the stator is press-fitted in the motor housing;

FIG. 6A is a fragmentary front view similar to FIG. 3A, but showing an electric compressor according to another embodiment of the present invention;

FIG. 6B is a fragmentary sectional view taken along the line A-A of FIG. 6A;

FIG. 6C is a fragmentary sectional view taken along the line B-B of FIG. 6A;

FIG. 7 is a perspective view of the guide member of the electric compressor of FIG. 6A;

FIG. 8 is a fragmentary perspective view of the housing of FIGS. 6B and 60;

FIG. 9 is a fragmentary longitudinal sectional view of the electric compressor of FIG. 6A, showing a state in which the stator is press-fitted in the housing;

FIG. 10A is a fragmentary front view similar to FIGS. 3A and 6A, but showing an electric compressor according to still another embodiment of the present invention;

FIG. 10B is a fragmentary sectional view taken along the line A-A of FIG. 10A;

FIG. 100 is a fragmentary sectional view taken along the line B-B of FIG. 10A;

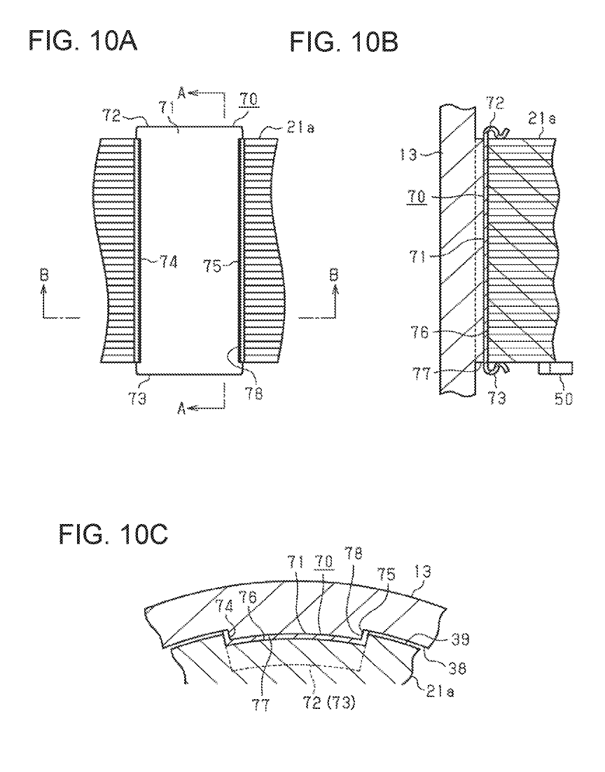

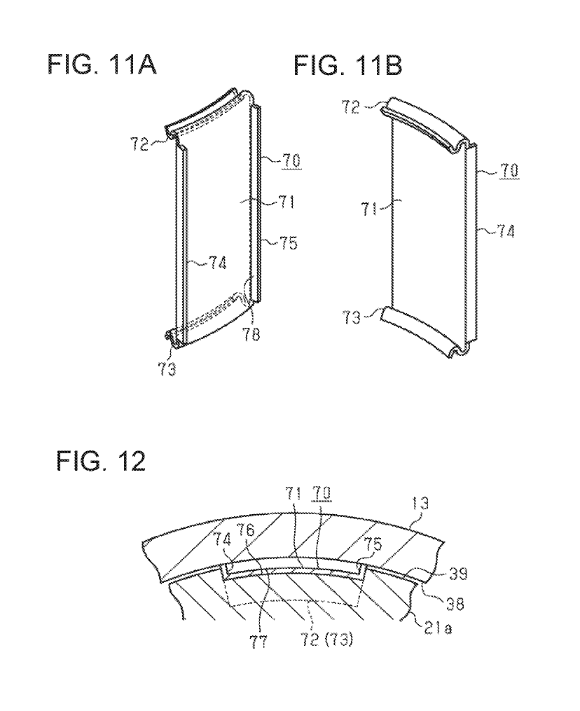

FIG. 11A is a perspective view of a guide member of the electric compressor of FIG. 10A;

FIG. 11B is a perspective view of the guide member of the electric compressor of FIG. 10A; and

FIG. 12 is a fragmentary sectional view similar to FIG. 100, but showing yet another embodiment.

### DETAILED DESCRIPTION OF THE EMBODIMENTS

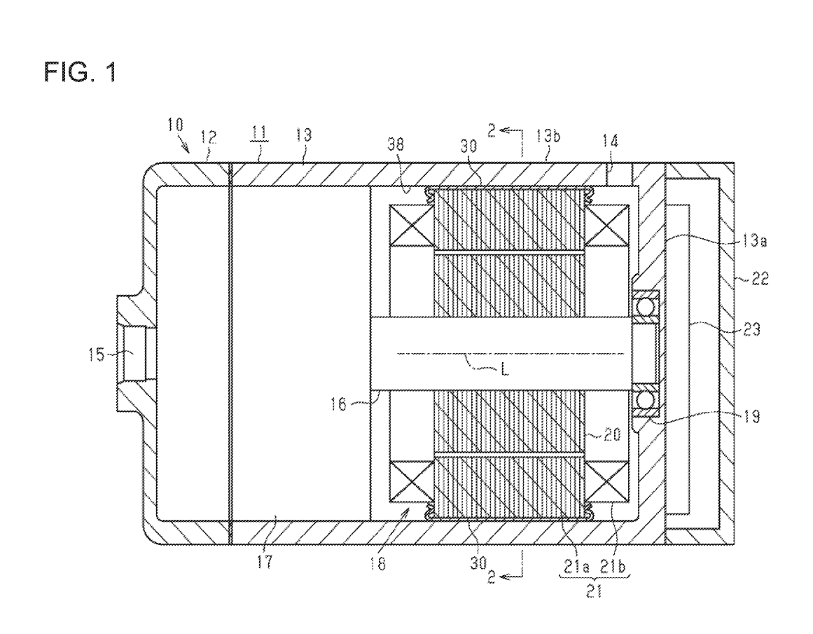

The following will describe an embodiment according to the present invention with reference to the accompanying drawings. An electric compressor according to the present embodiment is designated by 10 and used for a vehicle air conditioner. Referring to FIG. 1, the electric compressor 10 has a housing 11 including a discharge housing 12 and a motor housing 13 connected to the discharge housing 12 both of which have a bottomed cylindrical shape and are made of a metal such as aluminum alloy. The motor housing 13 has therethrough an inlet port 14 that is connected to an external refrigerant circuit not shown in the drawing. The motor housing 13 has a bottom wall 13a and a cylindrical side wall 13b extending axially of the compressor from the outer peripheral edge of the bottom wall 13a. The discharge housing 12 has therethrough an outlet port 15 that is connected to the external refrigerant circuit.

The motor housing 13 has therein a rotary shaft 16, a compression portion 17 having a compression chamber therein and driven by the rotary shaft 16 for compressing refrigerant gas, and an electric motor 18 rotating the rotary shaft 16. As the compression portion 17, a scroll type compressor, a piston type compressor, or a vane type compressor may be applied. The compression portion 17 and the electric motor 18 are disposed side by side in the direction of the rotational axis L of the rotary shaft 16. As shown in FIG. 1, the electric motor 18 is disposed closer to the bottom wall 13a of the motor housing 13 than the compression portion 17 is.

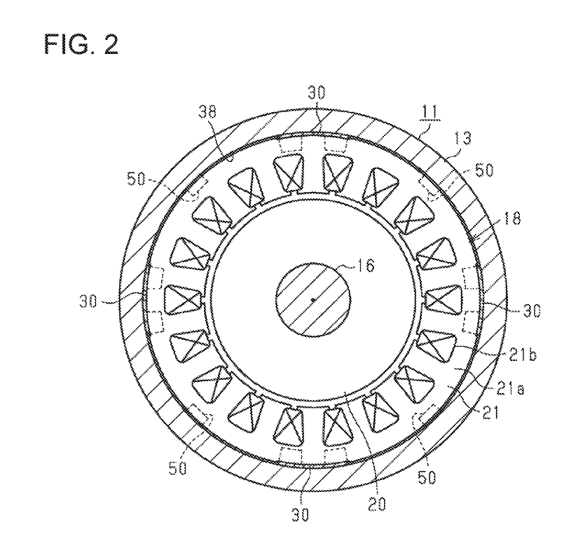

The rotary shaft 16 is rotatably supported by the bottom wall 13a of the motor housing 13 through a bearing 19. As shown in FIGS. 1 and 2, the electric motor 18 has a rotor 20 mounted on the rotary shaft 16 for rotation therewith and a stator 21 surrounding the rotor 20. The rotor 20 is fixed on the rotary shaft 16. The stator 21 has a cylindrical stator core 21a and a coil 21b wound around the stator core 21a. The stator core 21a is made of a plurality of laminated core sheets made of a metallic magnetic material such as an electromagnetic steel.

Referring to FIG. 1, a cover 22 has a bottomed cylindrical shape and is fixed to the bottom wall 13a of the motor housing 13. A motor drive circuit 23 is accommodated in the space formed by the bottom wall 13a of the motor housing 13 and the cover 22 to drive the electric motor 18. The motor drive circuit 23 and the coil 21b are electrically connected with each other.

Thus, the electric compressor 10 includes the cylindrical motor housing 13, the rotary shaft 16 accommodated and rotatably supported in the motor housing 13, and the compression portion 17 compressing refrigerant gas with the rotation of the rotary shaft 16. The electric compressor 10 further includes the stator 21 accommodated in the motor housing 13 and fixed to the inner peripheral surface 38 of the motor housing 13, or, the inner peripheral surface of the side wall 13b, and the rotor 20 accommodated in the motor housing 13 and fixed on the rotary shaft 16.

As shown in FIGS. 1, 2, 3A, 3B, and 3C, the stator core 21a is fitted to the inner peripheral surface 38 of the motor housing 13 by press-fitting with guide members 30 provided on the outer peripheral surface 39 of the stator 21.

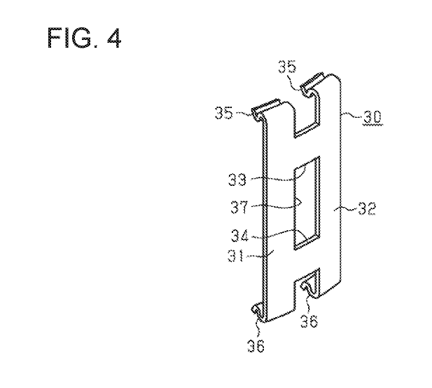

As shown in FIG. 4, the guide member 30 is made of a steel plate. As shown in FIG. 2, in the present embodiment, four guide members 30 are disposed 90 degrees apart from each other in the motor housing 13 in the peripheral direction of motor housing 13, which corresponds to the peripheral direction of the rotary shaft 16. That is, the plural guide members 30 (four guide members in the present embodiment) are disposed between the inner peripheral surface 38 of the motor housing 13 and the outer peripheral surface 39 of the stator core 21a of the stator 21 and spaced apart from each other in the peripheral direction of the rotary shaft 16.

The stator core 21a of the stator 21 is made of a plurality of laminated electromagnetic steel plates. If such stator 21 is press-fitted in the motor housing 13 without using guide members such as 30, stress due to press-fitting is applied directly to the stator core 21a. The provision of the guide members 30 between the inner peripheral surface 38 of the motor housing 13 and the outer peripheral surface 39 of the stator core 21a prevents stress in press-fitting from being applied directly to the stator core 21a.

As shown in FIG. 30, a plurality of recesses 40 is formed recessed from the outer peripheral surface 39 of the stator core 21a in the radial direction thereof and spaced apart from each other in the peripheral direction of the stator core 21a, which corresponds to the peripheral direction of the rotary shaft 16. The guide member 30 is fitted in the recess 40. The guide member 30 is received in the recess 40, and a part of the guide member 30 projects radially outward beyond the outer peripheral surface 39 of the stator core 21a.

In the present embodiment, the recess 40 is opened at the opposite ends of the stator core 21a in the axial direction of the rotary shaft 16. It is noted that, according to the present invention, the recess 40 may not be opened at the opposite ends of the stator core 21a in the axial direction of the rotary shaft 16.

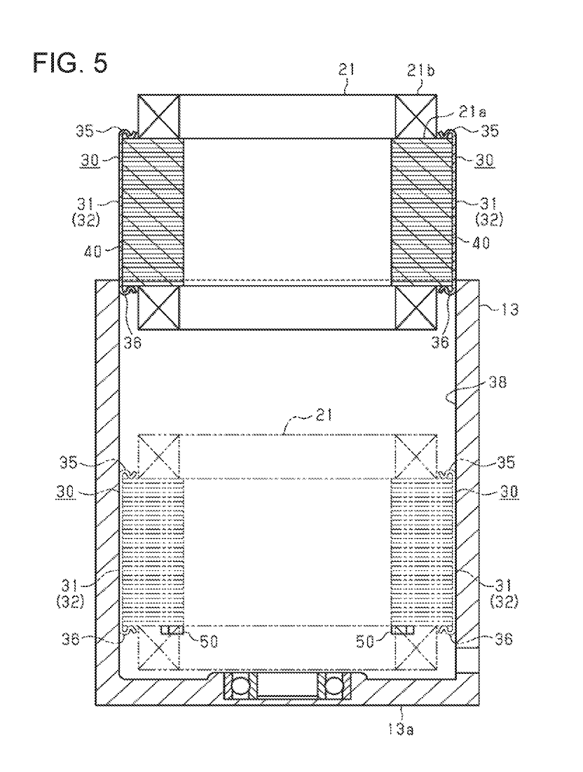

As shown in FIGS. 2 and 5, projections 50 are formed projecting radially inward from the inner peripheral surface 38 of the motor housing 13. The projections 50 serve as a stop to regulate movement of the stator core 21a in the axial direction of the rotary shaft 16 by contacting the stator core 21a or the guide members 30. In the drawings of the present embodiment, the projections 50 are shown to be in contact with the stator core 21a. That is, the press-fitting of the stator 21 into the motor housing 13 is completed when the stator core 21a is brought into contact with the projections 50. Although the projections 50 may be provided at positions where the projections 50 become in contact with the guide members 30, the projections 50 should preferably be provided away from the guide member 30 in order to prevent the guide members 30 from being deformed due to the contact with the projections 50.

As shown in FIG. 2, the four projections 50 are disposed 90 degrees apart from each other in the motor housing 13 in the peripheral direction of the motor housing 13 (the peripheral direction of the rotary shaft 16 relative to the motor housing 13). It is noted that the number of the projections 50 is not limited to four.

As shown in FIG. 4, the guide member 30 has a pair of strip portions 31, 32 of a rectangular shape and a pair of connecting portions 33, 34 connecting the paired strip portions 31, 32. Each of the strip portions 31, 32 has at the opposite longitudinal ends thereof bent portions 35, 36.

The strip portions 31, 32 are spaced away from each other in their width direction and integrated by the paired connecting portions 33, 34. The connecting portions 33, 34 are spaced away from each other in the longitudinal direction of the strip portions 31, 32. A rectangular hole 37 is defined by the strip portions 31, 32 and the connecting portions 33, 34.

It is noted that according to the present invention, the guide member 30 may have a structure in which a single strip portion or three strip portions or more are disposed and connected by connecting portions. Furthermore, the bent portions 35, 36 may be dispensed with.

The guide members 30 are fitted in the respective recesses 40 formed in the outer peripheral surface 39 of the stator core 21a. Specifically, each guide member 30 is disposed in the recess 40 of the stator core 21a in such an orientation that the length of the strip portions 31, 32 extends in the axial direction of the rotary shaft 16.

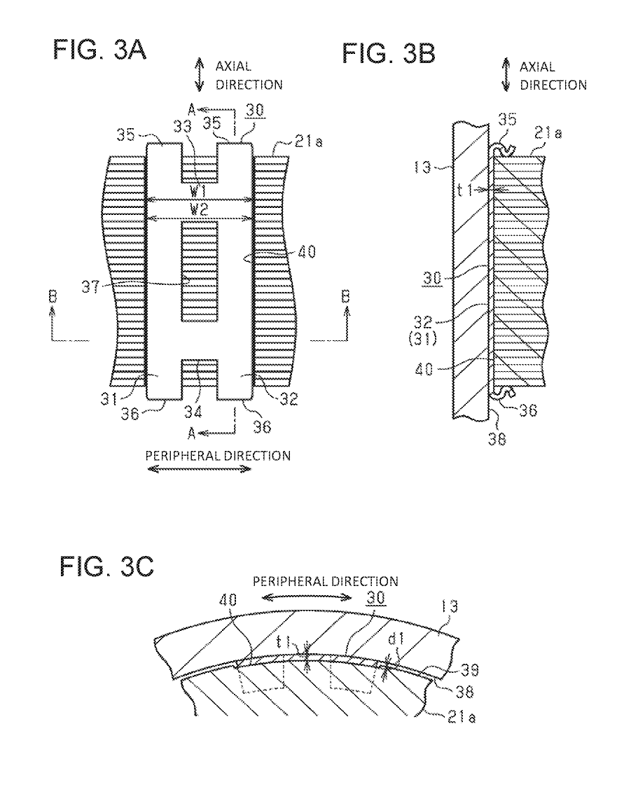

As shown in FIG. 3A, the recess 40 which is formed in the outer peripheral surface 39 of the stator core 21a has a width W1 extending in the peripheral direction of the stator core 21a and a length corresponding to the entire axial length of the stator core 21a. The width W1 of the recess 40 is slightly greater than the width W2 of the guide member 30 as measured in the peripheral direction of the stator core 21a. Thus, the guide member 30 is fitted without being displaced in the recess 40.

As shown in FIG. 3B, the guide member 30 is fitted in the recess 40 of the stator core 21a with the bent portions 35, 36 of the guide member 30 set in contact with the opposite axial ends of the stator core 21a.

As shown in FIG. 3C, the depth dl of the recess 40 is smaller than the thickness t1 of the guide member 30, so that a part of the guide member 30 is fitted in the recess 40 and other part of the guide member 30 projects radially outward beyond the outer peripheral surface 39 of the stator core 21a.

The following will describe the function of the electric compressor 10 of the present embodiment. As shown in FIG. 5, the stator 21 is press-fitted from the solid-line position to the predetermined fitting position indicated by the phantom line in the motor housing 13 through the guide members 30.

By disposing the guide members 30 between the inner peripheral surface 38 of the motor housing 13 and the outer peripheral surface 39 of the stator core 21a, pressure is not directly applied to the stator core 21a in press-fitting of the stator core 21a, thereby to protect the stator core 21a.

The structure in which the guide member 30 is fitted in the recess 40 formed in the outer peripheral surface 39 of the stator core 21a prevents the guide member 30 from being moved in the peripheral direction of the stator core 21a. That is, the guide member 30 is prevented from the slipping or displacement in the peripheral direction of the rotary shaft 16 relative to the stator core 21a. As a result, the guide member 30 may be disposed at any position in the peripheral direction of the rotary shaft 16 between the inner peripheral surface 38 of the motor housing 13 and the outer peripheral surface 39 of the stator core 21a without a contact of the stator core 21a with the inner peripheral surface 38 of the motor housing 13.

In the electric compressor of the above-cited Japanese Patent Application Publication 2014-20231, the guide members may be moved in the peripheral direction of the rotary shaft in press-fitting the guide-member, with the result that the stator core may be damaged by the contact of the stator core and the housing.

According to the present embodiment, the guide members 30 are prevented from being moved relative to the stator core 21a in the peripheral direction of the rotary shaft 16. Therefore, the contact of the stator core 21a and the inner peripheral surface 38 of the motor housing 13 is prevented.

According to the above-described embodiment, the following advantageous effects are obtained.

(1) The guide members 30 which are fitted in the recesses 40 formed in the stator core 21a are prevented from being moved relative to the stator core 21a in the peripheral direction of the rotary shaft 16 and, therefore, the contact of the stator core 21a and the inner peripheral surface 38 of the motor housing 13 is prevented.

(2) The guide members 30 are fitted in the recesses 40 and a part of the guide members 30 projects radially outward beyond the outer peripheral surface 39 of the stator core 21a. Such a structure prevents the contact of the stator core 21a and the inner peripheral surface 38 of the motor housing 13.

(3) In the structure in which the guide members 30 are fitted in the recesses 40 of the stator core 21a with the bent portions 35, 36 facing the opposite axial ends of the stator core 21a, the movement of the guide members 30 relative to the stator core 21a in the axial direction of the rotary shaft 16 is restricted.

(4) The projections 50 which are provided on the inner peripheral surface 38 of the motor housing 13 serve as stops to regulate the movement of the stator core 21a in the axial direction of the rotary shaft 16, so that the stator core 21a does not move closer to the bottom wall 13a.

The present invention is not limited to the above-described embodiment; but may be modified into various alternative embodiments, as exemplified below.

The guide member 30 may be replaced with a guide member 60 and the motor housing 13 may be formed in the inner peripheral surface thereof with engagement holes 62, which will described later.

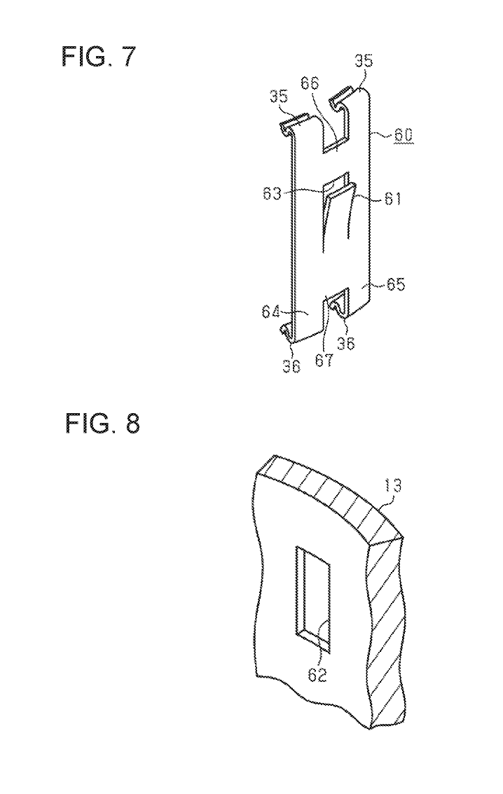

As shown in FIG. 7, the guide member 60 includes a pair of strip portions 64, 65 and a pair of connecting portions 66, 67, each having substantially the same shape as its counterpart strip portions 31, 32 or connecting portions 33, 34 of the guide member 30.

The guide member 60 further includes an engagement portion 61 that is disposed between the paired strip portions 64, 65 and between the connecting portions 66, 67 and projects from the connecting portion 67 radially outward of the stator core 21a, and an accommodation hole 63 that is formed through the guide member 60 by bending the engagement portion 61. The engagement portion 61 is elastically deformed by receiving load from the direction opposite to the direction in which the engagement portion 61 projects, so that the accommodation hole 63 receives the engagement portion 61. The guide member 60 differs from the guide member 30 in that the engagement portion 61 is provided in a position corresponding to the hole 37 of the guide member 30. The engagement portion 61 of the guide member 60 is curved in an arc-like shape from the connecting portion 67 toward the distal end thereof.

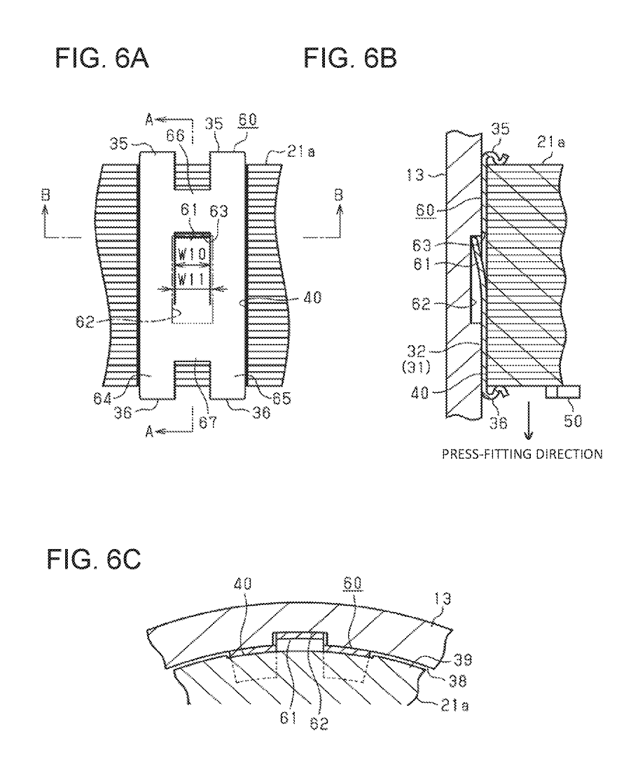

The motor housing 13 has in the inner peripheral surface thereof a plurality of engagement holes 62 (one hole being shown in FIG. 8) to receive therein the engagement portion 61. In the present embodiment, the engagement hole 62 is provided in the form of a recess. As shown in FIG. 6A, the width W11 of the engagement hole 62, or the dimension of the engagement hole 62 as measured in the peripheral direction of the rotary shaft 16 is slightly greater than the width W10 of the engagement portion 61, or the dimension of the engagement portion 61 as measured in the peripheral direction of the rotary shaft 16. Thus, with the engagement portion 61 inserted in the engagement hole 62, the movement of the stator 21 in the peripheral direction of the rotary shaft 16 is regulated.

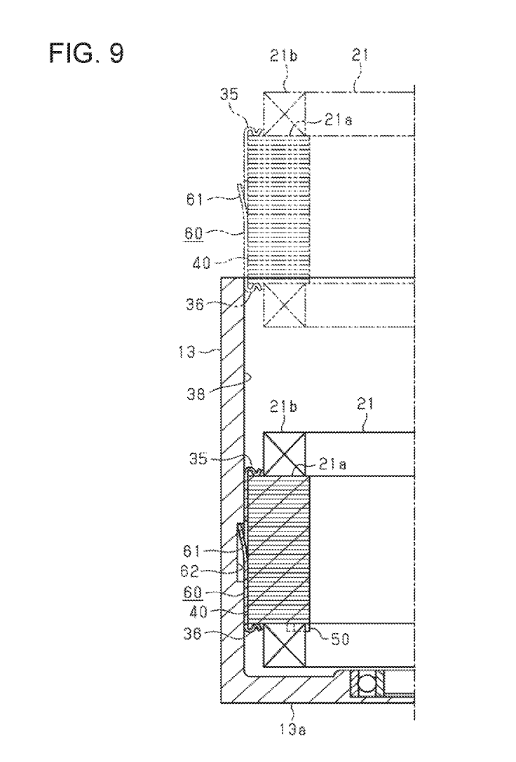

In the press-fitting of the stator core 21a, the engagement portion 61 is brought into contact with the inner peripheral surface 38 of the motor housing 13, and, being pressed, elastically deformed into a flat state by receiving load from the direction opposite to the direction in which the engagement portion 61 projects. Thus, the engagement portion 61 is brought into and received by the accommodation hole 63. When the engagement portion 61 comes to the position of the engagement hole 62 and is placed in the engagement hole 62, as shown in FIG. 9, the engagement portion 61 is restored to its bent state, receiving no load from the inner peripheral surface 38 of the motor housing 13. That is, the guide member 60 has the accommodation hole 63 to receive the engagement portion 61 when the engagement portion 61 is elastically deformed by receiving load from the direction opposite to the direction in which the engagement portion 61 projects.

Therefore, the provision of the engagement portion 61 and the engagement hole 62 permits to regulate movement of the guide member 60 in the peripheral direction of the rotary shaft 16 relative to the stator core 21a.

It is noted that according to the present invention, the number of the engagement portions 61 is not limited and also that the accommodation hole 63 may be provided in the form of a recess. The engagement portion 61 of the guide member 60 of a rectangular shape and bent in an arc-like shape from the connecting portion 67 may be formed otherwise. The guide member 60 may dispense with the accommodation hole 63. That is, the guide member may be formed having only a plate and an engagement portion projecting from the plate radially outward of the rotary shaft, or in the thickness direction of the plate. For example, it is conceivable to provide a guide member having only a plate and an engagement portion having a hemispherical shape and projecting from the plate.

Although the motor housing 13 has therein the engagement holes 62 and the guide member 60 has therein the engagement portion 61, as shown in FIGS. 6, 7, and 8, engagement projections 77, which will be described later, may be projecting from the inner peripheral surface 38 of the motor housing 13, instead of the engagement holes 62, and a guide member 70 may have a recessed portion 78 which will be described later, instead of the guide member 60, as shown in FIGS. 10A, 10B, 100, 11A, and 11B.

As shown in FIGS. 10A, 10B, and 100, the engagement projections 77 are formed projecting radially inward from the inner peripheral surface 38 of the motor housing 13 toward the stator core 21a. The guide member 70 has therein the recessed portion 78 as an engagement hole to receive therein the engagement projection 77. Specifically, as shown in FIGS. 11A and 11B, the guide member 70 includes a single strip portion 71 having a rectangular shape, bent portions 72, 73 at the opposite longitudinal ends of the strip portion 71, and a pair of flanges 74, 75 that are formed at the opposite lateral sides of the strip portion 71. The flanges 74, 75 have a constant height as measured from the strip portion 71 and project in the thickness direction of the strip portion 71.

The bent portions 72, 73 are bent so as to project in the opposite direction to the projecting direction of the flanges 74, 75. As shown in FIG. 100, the guide member 70 is fitted in a recess 76 formed in the stator core 21a of the stator 21 in such a way that the flanges 74, 75 project radially outward of the stator core 21a. The depth of the recess 76 is greater than the thickness of the guide member 70 and the flanges 74, 75 of the guide member 70 project radially outward beyond the outer peripheral surface 39 of the stator core 21a, and the engagement projection 77 is fitted between the flanges 74, 75.

Such structure regulates the movement of the guide member 70 relative to the stator 21 in the peripheral direction of the rotary shaft 16. The engagement projection 77 projecting from the inner peripheral surface 38 of the motor housing 13 is not limited to the size shown in FIG. 10B, but it may be of any size as long as the stator core 21a is held securely in the press-fitting of the stator core 21a so that the position of the stator core 21a is not changed by the vibration of the electric compressor 10.

In the structure shown in FIGS. 10A, 10B, and 10C, flange portions may be provided extending in the peripheral direction of the rotary shaft 16 from the upper edges of the flanges 74, 75, or the edges of the flanges 74, 75 on the side thereof opposite from the strip portion 71. In this case, if the press-fitting may be performed through the flange portions, the flanges 74, 75 and the strip portion 71 may be spaced away from the engagement projection 77 and/or the recess 76. Furthermore, the size of the engagement projection 77 may be changed as long as the movement of the guide member 70 in the peripheral direction of the rotary shaft 16 relative to the motor housing 13 is regulated.

As shown in FIG. 12, the structure shown in FIGS. 10A, 10B, and 100 may dispense with the engagement projection 77. The number of the guide members 30, 60 or 70, which are spaced away from each other in the peripheral direction of the rotary shaft 16, may be changed as desired. The number may be two, three, five or more.

The guide members 30, 60 or 70 may be fixed to the stator core 21a with adhesive. Specifically, the guide members 30, 60 or 70 may be fixed to the stator core 21a with adhesive applied previously to the bottom of the recesses 40, 76. In this case, the guide members 30, 60 or 70 may dispense with the bent portions 35, 36, 72, and 73.

The shape of the guide member 30, 60 or 70 is not limited to a rectangular shape, but may be changed as long as part of the guide member 30, 60 or 70 extends radially outward beyond the rotary shaft 16 from the outer peripheral surface 39 of the stator core 21a.

The electric compressor 10 may be used for any other applications than vehicles.

What is claimed is:

1. An electric compressor comprising:
a cylindrical housing;
a rotary shaft accommodated and rotatably supported in the housing;
a compression portion compressing refrigerant gas by rotation of the rotary shaft;
a stator accommodated in the housing and fixed to an inner peripheral surface of the housing;
a rotor accommodated in the housing and fixed on the rotary shaft; and
a plurality of guide members disposed between the inner peripheral surface of the housing and an outer peripheral surface of a stator core of the stator; wherein a plurality of recesses is recessed in a radial direction of the rotary shaft on the outer peripheral surface of the stator core of the stator and spaced apart from each other in a peripheral direction of the rotary shaft, and wherein the guide members are fitted in the respective recesses with a part of the guide members projecting radially outward beyond the outer peripheral surface of the stator core.

2. The electric compressor according to claim 1, wherein at least one of the guide members includes an engagement portion that projects in the radially outward direction of the rotary shaft, and wherein an engagement hole is formed in the inner peripheral surface of the housing to receive the engagement portion.

3. The electric compressor according to claim 2, wherein the engagement portion is elastically deformed by receiving load from a direction opposite to a direction in which the engagement portion projects, and wherein the guide member has therein an accommodation hole that receives the engagement portion when the engagement portion is elastically deformed by receiving load from the direction opposite to the direction in which the engagement portion projects.

4. The electric compressor according to claim 1, wherein an engagement projection is formed projecting radially inwardly from the inner peripheral surface of the housing, and wherein the guide member includes an engagement hole that receives the engagement projection.

5. The electric compressor according to claim 1, wherein a projection is provided on the inner peripheral surface of the housing and projects in the radially inward direction of the rotary shaft, and wherein the projection serves as a stop to regulate movement of the stator core in an axial direction of the rotary shaft by contacting with the stator core or one of the guide members.
